(19) United States
(12) Patent Application Publication
(10) Pub. No.: US 2013/0047884 A1
(43) Pub. Date: Feb. 28, 2013

(54) Expandable Sponge

(71) Applicants: Karen Floyd, Spartanburg, SC (US); Angel Cox, Lyman, SC (US); Tom Wilke, Greenville, SC (US)

(72) Inventors: Karen Floyd, Spartanburg, SC (US); Angel Cox, Lyman, SC (US); Tom Wilke, Greenville, SC (US)

(21) Appl. No.: 13/479,693

(22) Filed: May 24, 2012

Related U.S. Application Data
(60) Provisional application No. 61/489,303, filed on May 24, 2011.
(60) Provisional application No. 61/537,437, filed on Sep. 21, 2011.

(51) Int. Cl. C09K 3/00

(52) U.S. Cl. 106/18.12

(57) ABSTRACT

A sponge having the following components by percentage of total weight of the sponge: polyoxyalkycene polyolo between about 15% to 45%; tolvene diisocyanate between about 5% to 25%; a flame retardant less than 10%; water less than 10%; polypropylene glycol between about 8% to 19%; slow rebound polyether between about 10% to 20% and silicone oil less than about 2% and wherein said sponge has a volume about 3.5 times less than expanded when compressed in a vacuum sealed package.

### CLAIM OF PRIORITY

This application claims priority on U.S. Provisional Patent Applications 61/489,303 filed May 24, 2011 and 61/537,437 filed Sep. 21, 2011.

### BACKGROUND OF THE INVENTION

1) Field of the Invention

The present invention relates to a sponge, and more specifically, to a sponge that has a compressed packaging arrangement for more efficient transportation, display and distribution.

2) Description of Related Art

Sponges are used in all aspects of constructions, cleaning, and general maintenance of everyday articles. Specifically, in the tile industry, sponges (tile grout sponges) are used to wipe damp grout from the wall and from the tiles. The sponge is used to clean most of the grout from the tiles after the grout has been applied between the tiles. The sponge is rinsed in a pail of water frequently, and wrung out between each rinsing. Due to the varying uses of the sponge, its working life is fairly short with several sponges needed for each tile job, based upon the square feet of the job. However, multiple sponges are generally needed for each job.

A tile grout sponge needs to have a sufficient surface area for handling the removal of excess grout from the tile and adjacent walls. Therefore, a grout sponge can measure generally 8 inches in length, two inches in height and 6 inches in width. This equates to a volume of 96 cubic inches. To transport and ship 1000 sponges would require 96,000 cubic inches or 55 cubic feet. Since the volume of air space in a sponge is roughly two-thirds air space, transportation and shipping amount to mostly transporting and shipping air. Further, when commercial sponges are placed in a retail location, the display area of the sponges are displaying mostly air. Displaying 100 sponges required 9,600 cubic inches (or five and one-half cubic feet). It would be advantageous to have a packaging system that allowed more sponges to be displayed in the same cubic feet than with traditional grout sponges.

Attempts to manufacture compressed sponges have been made, as shown in U.S. Pat. No. 6,034,051. This patent describes an expandable sponge article, initially substantially anhydrous useful for aromatizing and/or freshening and de-wrinkling clothes and linens (e.g., towels, sheets, pillowcases and the like) consisting of a relatively small expandable sponge having contained in the interstices thereof perfume oil and a fragrance substantivity/fabric relaxing substance. This patent is specifically limited to be used on clothing and/or linens in need of de-wrinkling and aromatization and/or freshening, and such use is effected in an automatic dryer (which has different “cycles”); on operation of the “fluff” cycle. Further, the sponge in this patent is activated by placing water thereon and thereby hydrating and thus expanding the sponge article.

In many applications, requiring the sponge to have water placed on it for “activation” is unacceptable as a fully expanded dry sponge is needed. For example, a chemical solution applied with a sponge cannot be initially wetted prior to having the chemical solution applied to it else the chemical solution will be unnecessarily diluted.

Accordingly, it is an object of the present invention to provide a sponge that can be transported in a compressed arrangement and expanded for use.

Accordingly, it is an object of the present invention to provide a sponge that will expand without the need for adding any material such as water.

### SUMMARY OF THE INVENTION

The above objectives are accomplished according to the present invention by providing a sponge including components taken from the group of polyoxyalkycene polyolo in an amount of between about 15% to 45% of the total weight of the sponge; tolvene diisocyanate in an amount of between about 5% to 25% of the total weight of the sponge; a flame retardant in an amount less than 10% of the total weight of the sponge; water in an amount less than 10% of the total weight of the sponge; polypropylene glycol in an amount of between about 8% to 19% of the total weight of the sponge; slow rebound polyether in an amount of between about 10% to 20% of the total weight of the sponge and silicone oil in an amount less than about 2% of the total weight of the sponge.

The sponge can be contained in a vacuum sealed packaging containing the sponge in a compressed arrangement wherein the sponge has a volume of between about 12 cubic inches and 47 cubic inches; and, an expanded arrangement wherein the sponge is removed from the packaging wherein the sponge has a volume of between about 70 cubic inches and 145 cubic inches.

The sponge can have a height of about 8⅝ inches, width of about 6 7/16 inches and depth of about 7/16 inches in the compressed arrangement and a height of about 7½ inches, width of about 5½ inches and depth of about 2 1/16 inches so that the sponge expands to a usable size relative to its compressed arrangement.

The sponge can include a relief disposed on one side of the sponge wherein the relief is printed prior to compression of the sponge so that the relief, after compression, is about the same dimensions after expansion as prior to compression.

The sponge can include an abrasion area attached to one side of the sponge.

The flame retardant can contain components taken from the group consisting of: aluminum hydroxide ATH, magnesium hydroxide MDH, huntite, hydromagnesite, hydrates, red phosphorus, boron compounds, organohalogen compounds, organophosphorus compounds and silicone oil or any combination of these.

The slow rebounding polyether can have one or more of the following physical characterizes: a hydroxyl value (mgKOH/g) of between about 230-250, acidity (mgKOH/g) of less than of equal to 0.08, viscosity (cps/25° C.) of about 240 and moisture content (%) of less than or equal to 0.08.

The invention is also directed to a method of manufacturing a sponge comprising: providing a sponge having components selected from the group consisting of: includes the following weight of components: polyoxyalkycene polyolo, tolvene diisocyanate, a flame retardant, water, polypropylene glycol, slow rebound polyether, silicone oil and any combination of these; placing the sponge in a vacuum sealable package; vacuum sealing the sponge in the packaging reducing the volume of the sponge about three times; and, distributing the packaged sponge to a wholesaler, retailer or end user.

A plurality of compressed sponges can be packaged inside a secondary packaging along with an expanded sponge for distribution.

### BRIEF DESCRIPTION OF THE DRAWINGS

The invention will be more readily understood from a reading of the following specification and by reference to the accompanying drawings forming a part thereof, wherein an example of the invention is shown and wherein:

FIG. 1 is a top view of the invention;

FIG. 2 is a side view of the invention;

FIG. 3 is a side view of the invention; and,

FIG. 4 is a side and top view of the invention expanded;

### DETAILED DESCRIPTION OF A PREFERRED EMBODIMENT

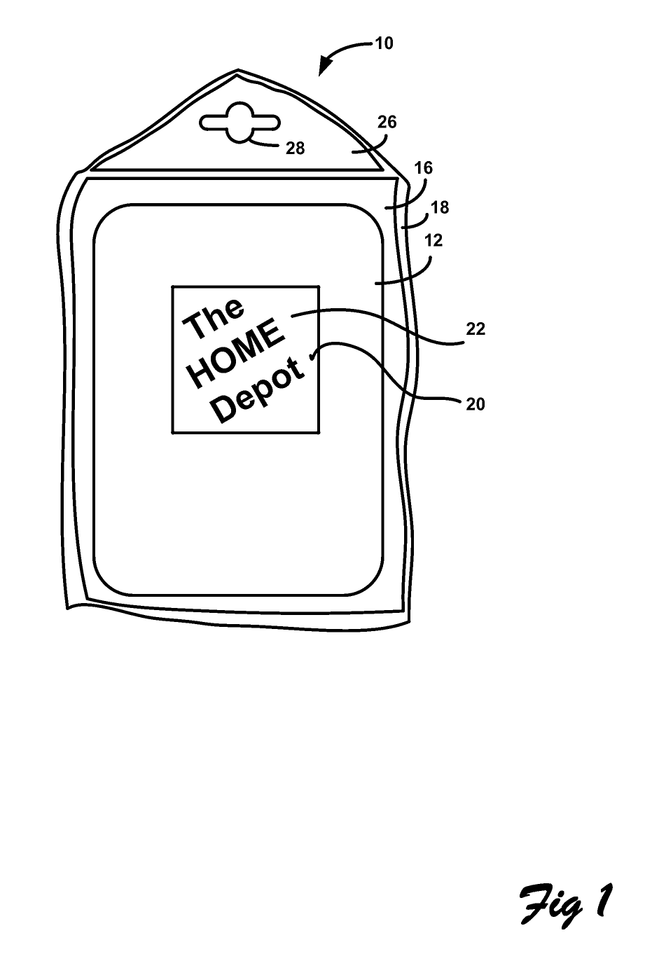

With reference to the drawings, the invention will now be described in more detail. Referring to FIG. 1, a packaging and sponge combination is shown. A sponge 12 is enclosed in packaging 14. A sponge containment area 16 contains the sponge and can be vacuum sealed with seal 18. Sponge 12 can include logo area 20 that can contain a logo or text 22. When the air is evacuated from sponge containment area 16, the volume of the sponge is compressed up to ten times its original volume. Hang tag area 24 is connected in the packaging and can include hang tag vacuum area 26 and opening 28 defined in the hang tag vacuum area for allowing the packaging to hang from a display rack. When compressed due to evacuating air from the sponge containment area, up to ten sponges can be displayed in the same area as a traditional sponge.

In one embodiment, the containment area extends at least ¼ inch from the perimeter of the compressed sponge. The hang tag need not be included in the packaging when the sponge is packaged for a display case. The display case can be designed as a foldable display case as shown in FIG. 9 allowing for packaging to includes hang tags or no hand tags. The floor display can be folded into a generally flat arrangement and can be either placed in a shipping box with the compressed packaged sponges or attached to the top of a shipping box containing compressed packaged sponges. The combination of the floor display and the compressed sponges insures that the sponges can be displayed in a footprint that does not require shelving and will allow for floor displays to be periodically replaced. The floor display in the folded configuration can be unfolded along predetermined fold lines and unfolded or assembled resulting in an upright display for containing compressed packaged sponges.

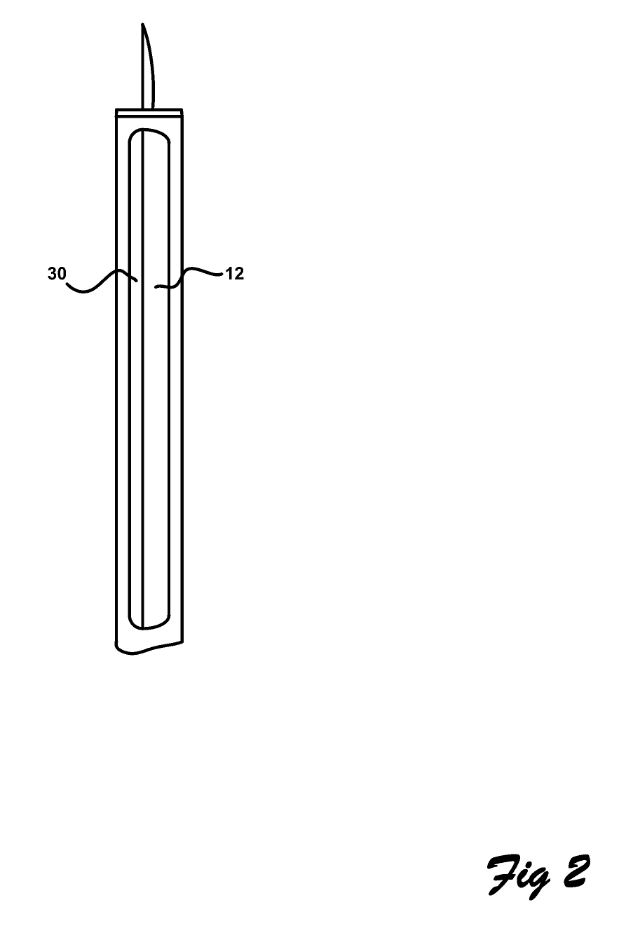

Referring to FIG. 2, sponge 12 can include an abrasion area 30 that is also compressed when air is evacuated from the sponge containment area. In one embodiment, the compressed sponge's height is in a range of 1/16 inch to 7/16 inch and expanded, its height is in a range between 1½ inches to 2½ inches.

In one embodiment, the composition of the sponge can include one or more of the following components: polyoxyalkycene polyolo, tolvene diisocyanate, T II stannous octoate; GLR-2000; 8283 fire retardant silicon oil; phosphorus-based fire retardant (i.e. antiblaze RX35 as provided by Albemarle); fire retardant silicon oil; and LP-00 polypropylene glycol. A flame retardant can be included taken from the group consisting of aluminum hydroxide ATH, magnesium hydroxide MDH, huntite, hydromagnesite, hydrates, red phosphorus, boron compounds, organohalogen compounds, organophosphorus compounds. The sponge can also include a slow rebound polyether. In one embodiment, the slow rebounding polyether has a hydroxyl value (mgKOH/g) of between about 230-250, acidity (mgKOH/g) of less than or equal to 0.08, viscosity (cps/25° C.) of about 240 and moisture content (%) of less than or equal to 0.08.

In one embodiment, the components of the sponge are in the following ranges in percent of weight:

| Component | Weight percentage (%) |
|---|---|
| polyoxyalkylene polyolo | 15.00 to 45.00 |
| tolvene diisocyanate | 05.00 to 25.00 |
| flame retardant | 03.00 to 08.00 |
| slow rebound polyether | 10.00 to 20.00 |
| H₂O | 01.00 to 06.00 |
| polypropylene glycol | 08.00 to 19.00 |
| silicone oil | 00.01 to 02.00 |

Once the seal is opened and the sponge is removed from the sponge containment area, the sponge expands to an operational size without the need to add water.

In its compressed size, the logo area (or relief) can have a depth in the range of 1/32 inches and 1/16 inches and ⅛ inches. The logo itself can be imprinted into the surface of the sponge using a heated brand prior to compression of the sponge creating a relief. The logo can have lettering having a height in the compressed form in the range of 1/32 inches to 1/16 inches and in the range of 1/16 and ⅛ inches in the expanded form. In one embodiment, the weight of the sponge and the packaging is less than 0.11 ounces. The weight of the packaging without the sponge is less than 0.06 ounces and the weight of the expanded sponge is less than 0.06 ounces.

In one embodiment, the sponge and packaging in the compressed size having height: 8¾ inches (22.2 cm); width: 6½ inches (16.5 cm) and depth: ⅜ inch (1 cm). The covering extends ½ inch around the compressed sponge. The volume is 366.3 cm³ and the density is 0.1238 g/cm³. When expanded, the sponge can have the dimensions: height: 7¾ inches; width: 5¼ inches and depth: 2 inches.

In one embodiment, the compressed sponge is 8⅝ inches in height, 6 7/16 inches in width and 7/16 inches in depth and when expanded is 7½ inches in height, 5½ inches in width and 2 1/16 inches in depth.

In one packaging configuration, five compressed sponges are packaged with one expanded sponge contained in a secondary packaging. This provides a combination of efficiently compressed packaging to provide significantly more sponges in the same footprint as an expanded sponge while also allowing the purchaser or user to see the expanded sponge and its dimensions. In this embodiment, the combination can be 8⅝ inches in height, 6 7/16 inches in width and 4¼ inches in depth.

In the event that seal 18 is compromised and/or air is otherwise allowed to enter sponge containment area 12, the sponge containment area will prevent the sponge from fully expanding.

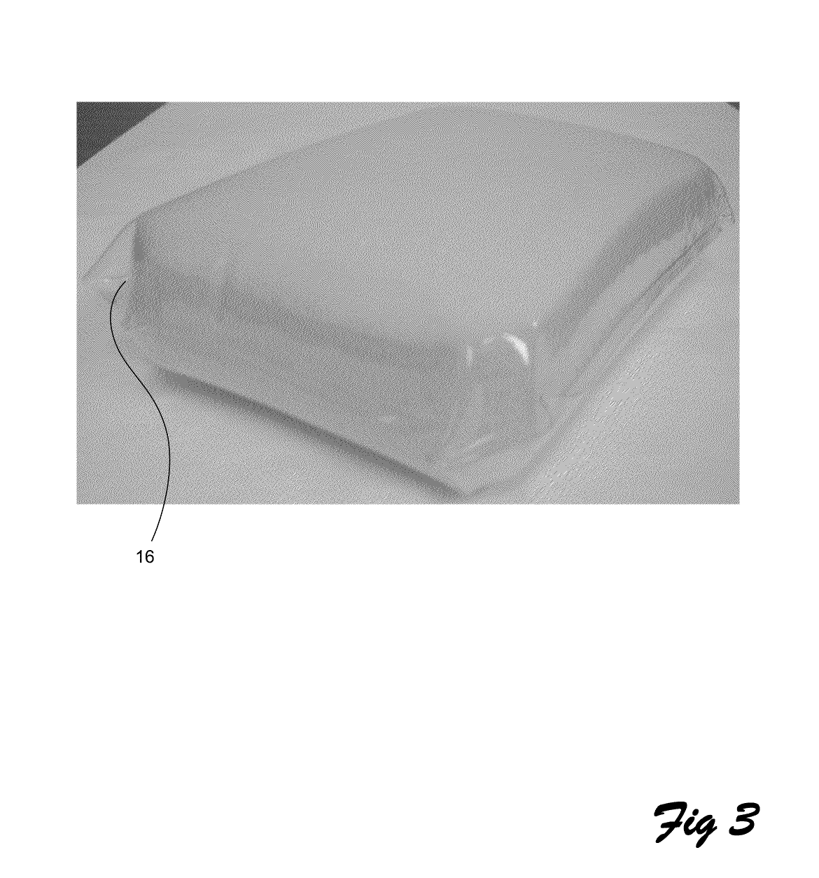

As shown in FIG. 3, air has entered sponge containment area 16. The sponge expands, but is contained by the sponge containment area and does not expand to its operational size. In one embodiment, the sponge expands to a height in the range of ¼ inch and 1 inch. The sponge expands by air entering the sponge containment area without the addition of water.

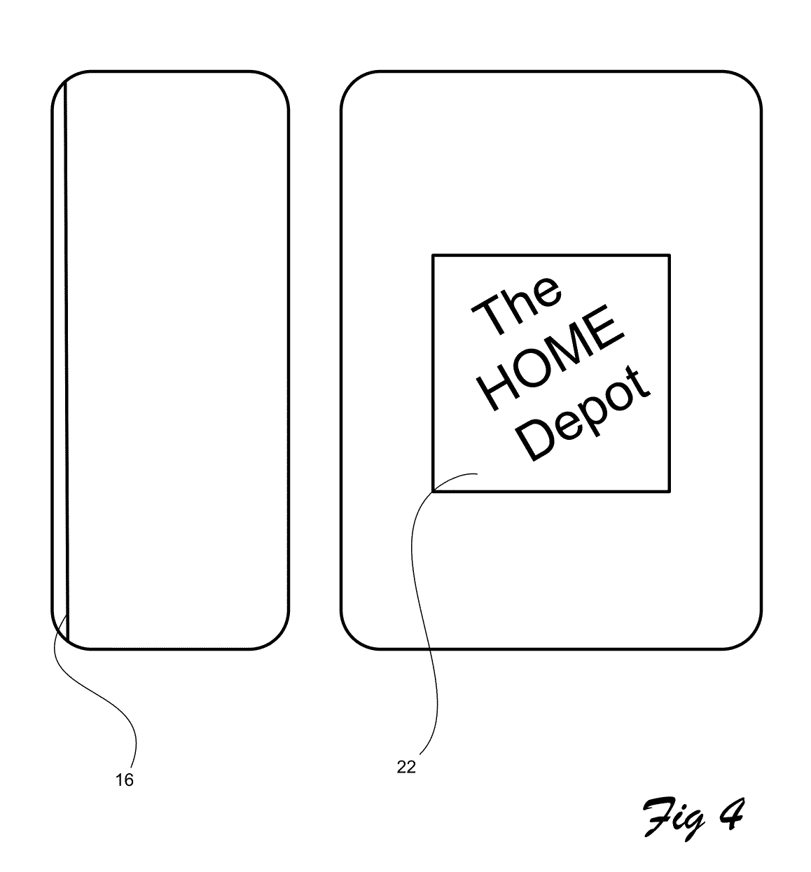

FIG. 4 illustrates the sponge expanded to its operational size removed from the sponge containment area. Logo or relief 22 is shown on one side with the abrasion pad 16 shown on the opposite side.

In operation, the method of packaging, transporting, displaying and distributing the sponge is now described. First, a sponge is cut from a large sponge raw material. The sponge is then branded with a heated brand to imprint the logo or relief in the logo area. The sponge is then received in the sponge containment area and air is evacuated from the sponge containment area and the sponge compresses. The sponge containment area is sealed. The sponge in its packaging is transported from a manufacturing location to a retail location. The sponge and packaging is displayed at the retail location. The sponge is distributed to a user. The user removes the sponge from the packaging allowing the sponge to expand to an operational size.

While a preferred embodiment of the invention has been described using specific terms, such description is for illustrative purposes only, and it is to be understood that changes and variations may be made without departing from the spirit or scope of the following claims.

What is claimed is:

1. A sponge comprising:
polyoxyalkycene polyolo in an amount of between about 15% to 45% of the total weight of the sponge;
tolvene diisocyanate in an amount of between about 5% to 25% of the total weight of the sponge;
a flame retardant in an amount less than 10% of the total weight of the sponge;
water in an amount less than 10% of the total weight of the sponge;
polypropylene glycol in an amount of between about 8% to 19% of the total weight of the sponge;
slow rebound polyether in an amount of between about 10% to 20% of the total weight of the sponge silicone oil in an amount less than about 2% of the total weight of the sponge;
a vacuum sealed packaging containing said sponge in a compressed arrangement wherein said sponge has a volume of between about 12 cubic inches and 47 cubic inches; and,
an expanded arrangement wherein said sponge is removed from said packaging wherein said sponge has a volume of between about 70 cubic inches and 145 cubic inches.

2. The sponge of claim 1 wherein said sponge in said compressed arrangement is about 24 cubic inches and 85 cubic inches in said expanded arrangement.

3. The sponge of claim 1 wherein said sponge has a height of about 8⅝ inches, width of about 6 7/16 inches and depth of about 7/16 inches in said compressed arrangement and a height of about 7½ inches, width of about 5½ inches and depth of about 2 1/16 inches so that said sponge expands to a usable size relative to its compressed arrangement.

4. The sponge of claim 1 including a relief disposed on one side of the sponge wherein said relief is printed prior to compression of the sponge so that said relief, after compression, is about the same dimensions after expansion as prior compression.

5. The sponge of claim 1 wherein said vacuum sealed packaging has a thickness of about 1/16 inch.

6. The sponge of claim 1 including an abrasion area attached to one side of said sponge.

7. A sponge comprising:
components selected from the group consisting of polyoxyalkycene polyolo;
tolvene diisocyanate; polypropylene glycol; slow rebound polyether; silicone and any combination of these;
a compressed arrangement wherein said sponge is vacuum sealed in a package having a thickness of about ⅙ inches; and,
an expanded volume greater than three times the compressed volume when said sponge is removed from said package.

8. The sponge of claim 8 wherein said sponge includes an abrasion pad on one side and a relief on the opposite side.

9. The sponge of claim 7 including polyoxyalkycene polyolo in an amount of at least 30% by weight of the total weight of said sponge.

10. The sponge of claim 7 including a flame retardant.

11. The sponge of claim 10 wherein said flame retardant contains components taken from the group consisting of: aluminum hydroxide ATH, magnesium hydroxide MDH, huntite, hydromagnesite, hydrates, red phosphorus, boron compounds, organohalogen compounds, organophosphorus compounds or any combination of these.

12. The sponge of claim 10 wherein said flame retardant includes silicone oil.

13. The sponge of claim 7 wherein said slow rebounding polyether has one or more of the following physical characterizes: a hydroxyl value (mgKOH/g) of between about 230-250, acidity (mgKOH/g) of less than of equal to 0.08, viscosity (cps/25° C.) of about 240 and moisture content (%) of less than or equal to 0.08.

14. The sponge of claim 7 including an opening defined in said package so that said packaged can be hung for display when said package is sealed and said sponge is in said compressed arrangement.

15. The method of manufacturing a sponge comprising:
providing a sponge having components selected from the group consisting of:
polyoxyalkycene polyolo, tolvene diisocyanate, a flame retardant, water, polypropylene glycol, slow rebound polyether, silicone oil and any combination of these;
placing said sponge in a vacuum sealable package;
vacuum sealing said sponge in said packaging reducing said volume of said sponge about three times; and,
distributing said packaged sponge to a wholesaler, retailer or end user.

17. The sponge of claim 15 wherein said sponge includes the following weight of components: polyoxyalkycene polyolo in an amount of between about 15% to 45% of the total weight of the sponge; tolvene diisocyanate in an amount of between about 5% to 25% of the total weight of the sponge; a flame retardant in an amount less than 10% of the total weight of the sponge; water in an amount less than 10% of the total weight of the sponge; polypropylene glycol in an amount of between about 8% to 19% of the total weight of the sponge; slow rebound polyether in an amount of between about 10% to 20% of the total weight of the sponge and silicone oil in an amount less than about 2% of the total weight of the sponge.

18. The method of claim 16 including placing a plurality of compressed sponges and packaging inside a secondary packaging along with an expanded sponge for distribution.

19. The method of claim 16 wherein said volume of the compressed sponge is between about 12 cubic inches and 47 cubic inches and said volume of the sponge expanded is between about 70 cubic inches and 144 cubic inches.

20. The method of claim 19 wherein the volume of the sponge is about 25 cubic inches compressed and about 85 cubic inches expanded.
